(19) United States
(12) Patent Application Publication
(10) Pub. No.: US 2025/0228217 A1
(43) Pub. Date: Jul. 17, 2025

(54) FARMING SYSTEM AND METHOD

(71) Applicants: OY HITIS FORELL AB, Hiittinen (FI); ALTRUM OY, Tuusula (FI)

(72) Inventors: Rune FIHLMAN, Hiittinen (FI); Dan FIHLMAN, Turku (FI)

(21) Appl. No.: 18/702,717

(22) PCT Filed: Aug. 31, 2022
(86) PCT No.: PCT/FI2022/050566

§ 371 Date: Apr. 18, 2024

(30) Foreign Application Priority Data
Oct. 21, 2021 (FI) 20216091

(51) Int. Cl. A01K 61/65

(52) U.S. Cl. CPC A01K 61/65

(57) ABSTRACT

The disclosure is related to a farming system and method for farming aquatic animals, such as fish and shellfish. The farming system comprises a floating structure, a farming pipe, to the ends of which end pieces are attached, which have openings in order to enable the flow of water through the farming pipe, and connecting means, with which the farming pipe is connected to the floating structure, so that the farming pipe is substantially horizontal in the water.

### TECHNICAL FIELD OF THE INVENTION

The invention relates to a farming system and method for farming aquatic animals, such as fish and shellfish, according to the preambles of the independent claims presented below.

### BACKGROUND OF THE INVENTION

Aquatic animals, such as fish and shellfish, are farmed for food. Several different systems have for example been developed for fish farming, which systems can be divided into fish farming systems based on an open or closed water circulation. In open systems, fish are farmed in net pens, while in closed systems water-proof pools are used for farming fish. Open systems are intended for use in water systems, such as a sea, lake or river. Closed systems on the other hand are placed on dry land.

A problem with open fish farming systems is the environmental burden they cause. Waste produced by the fish can pass outside the net pens, whereby large amounts of nutrients, such as nitrogen and phosphorus, end up in the water system. Closed fish farming systems do not have a corresponding problem, because in them, the water is not changed, but cleaned, oxidized and recycled back into the farming pools. A problem with closed systems on the other hand is their structural complexity and the uncertainties related to the operation of chemical cleaning processes needed in them.

A problem with known fish farming systems is additionally that the fish easily get sick in them, due to which the production quantities may remain very low. As at least a part of the reason for the fish getting sick is considered stress, which is caused by the fish having to swim in circles in the farming pools.

### OBJECTS OF THE INVENTION

It is an object of the present invention to reduce or even completely eliminate the above-mentioned problems and flaws, which appear in the prior art.

It is an object of the present invention to provide a system and a method for farming aquatic animals, such as fish and shellfish. It is additionally an object of the present invention to provide a farming system, which can be used in a water system and the use of which is based on an open water circulation.

It is also an object of the present invention to provide a farming system and a farming method, which reduce the stress of aquatic animals being farmed and thus improve their well-being, and with the aid of which production quantities are large.

It is further an object of the present invention to provide a farming system and a farming method, the effects of which on the water system are minor. It is also an object of the present invention to provide a farming system and a farming method, by means of which the waste produced by aquatic animals, such as fish and shellfish, can efficiently be collected, whereby the burden on the water system is very minor.

The above-mentioned disadvantages can be reduced or even completely eliminated, and the above-mentioned objects are attained with the present invention, which is characterised in what is defined in the characterising parts of the independent claims presented further below.

Some embodiments according to the invention are disclosed in the dependent claims presented further below.

### DESCRIPTION OF THE INVENTION

A typical farming system according to the invention comprises a floating structure, a farming pipe, to the ends of which end pieces are attached, which have openings in order to enable the flow of water through the farming pipe, and connecting means, with which the farming pipe is connected to the floating structure, so that the farming pipe is substantially horizontal in the water.

The farming system according to the invention is suited for farming aquatic animals, such as fish and shellfish. The aquatic animals are farmed in a farming pipe. The farming system is intended for use in a water system, such as a sea, lake or river. The system is based on open water circulation, which utilizes the natural current of the water system. In the farming system according to the invention, the water can flow through the farming pipe meant for farming aquatic animals, such as fish and shellfish. Both ends of the farming pipe are closed with end pieces, the openings in which are dimensioned so that the aquatic animals farmed in the farming pipes cannot fit through them and thus the aquatic animals cannot get out of the farming pipe. The farming pipe is connected with connecting means to a floating structure, with the aid of which the system floats in the water. A lifting force is directed to the floating structure in the water, which lifting force keeps the floating structure on the water surface. The farming pipe is meant to be arranged to be supported by the connecting means below the water surface. It is essential for the farming system according to the invention installed in a water system that the farming pipe is substantially horizontal in the water. The position of the farming pipe can diverge from the horizontal plane by at the most ±20 degrees, ±15 degrees, ±10 degrees or ±5 degrees.

The floating structure can comprise different floating means in order to provide the necessary lifting force. The floating structure advantageously comprises at least one pontoon, which is manufactured for example from metal, such as steel, or plastic. The number of pontoons and their size can be selected on a case-by-case basis, among others based on the dimensions and manufacturing material of the farming pipe. The pontoons can be connected to each other with a support structure, which can comprise a platform for the use and service of the system.

The farming pipe intended for farming aquatic animals can be manufactured for example from metal or plastic. The farming pipe is advantageously straight and rigid. The length of the farming pipe can be for example at the most 50 metres, at least 50 metres or at least 100 metres. The length of the farming pipe is advantageously 50-400 metres and very advantageously 100-200 metres. The farming pipe advantageously has a circular cross-section. An advantage of the farming pipe with a circular cross-section is that it can be made structurally very durable even with a low wall thickness and thus with a small material demand, whereby the mass of the farming pipe remains as low as possible. The inner diameter of the farming pipe can be for example at the most 10 metres, at least 10 metres or at least 20 metres. The inner diameter of the farming pipe is advantageously 10-50 metres and very advantageously 20-40 metres. The cross-section of the farming pipe can also have another shape than a circular shape, for example a rectangular shape. Instead of one farming pipe, the farming system can comprise several farming pipes intended for farming aquatic animals, which farming pipes are connected with connecting means to the floating structure. The number of farming pipes can for example be 2, 3, 4 or 5-10.

The end piece can be attached to the end of the farming pipe in a fixed manner or in a manner that can be opened. An advantage of the end piece which can be opened is that it makes it possible to place aquatic animals to be farmed into the farming pipe and to remove them from the farming pipe without a separate hatch arranged in the farming pipe. The openings in the end pieces can have for example a circular, rectangular or square shape. The maximal size of the opening is determined based on the size of the aquatic animal to be placed in the farming pipe. The diameter of a circular opening can for example be less than 10 millimetres, less than 30 millimetres, 10-200 millimetres or 200-500 millimetres. The length of the shortest side of a rectangular opening and the length of a side of a square opening can for example be less than 10 millimetres, less than 30 millimetres, 10-200 millimetres or 200-500 millimetres. The end piece attached to the end of the farming pipe can for example be a net, a grating or a perforated plate. The end piece can be manufactured for example from metal, such as steel, or plastic, such as nylon. The end piece can for example be a nylon net.

An advantage of the farming system according to the invention is that it reduces the stress of the aquatic animals being farmed and thus improves their well-being. Stress experienced by the fish is low, because the fish can swim against the water current. An advantage of the system according to the invention is also that it achieves a high growth rate of the aquatic animals, due to which the yearly production quantities are large. Additionally, an advantage of the farming system according to the invention is that its effects on the water system are minor, because the waste produced by the aquatic animals to a large part remains inside the farming pipe, from where it can easily be collected.

According to one embodiment of the invention, the connecting means comprise a first and a second cable, the first ends of which are attached in connection with the floating structure and the second ends in connection with the farming pipe. Because the farming pipe is hung onto the floating structure with cables, the farming pipe and the floating structure can move partly independently from each other. The arrangement thus improves the durability of the system, because typically, the forces directed at the floating structure on the water surface and the farming pipe below the water surface have different directions and/or magnitudes.

The first ends of the cables can be attached to the floating structure either directly or via some part or device attached to the floating structure. Correspondingly, the second ends of the cables can be attached to the farming pipe either directly or via some part or device attached to the farming pipe. The distance between the attaching points of the second ends of the first and second cable is advantageously at least 40%, and very advantageously at least 60% of the length of the farming pipe. Increasing the distance between the attaching points improves the stability of the farming pipe, and thus reduces the movement of the farming pipe in the water. Typically, the distance between the attaching points of the first ends of the cables is substantially the same as the distance between the attaching points of the second ends of the cables.

According to one embodiment of the invention, the connecting means comprise a first lifting device attached to the floating structure, to which lifting device the first end of the first cable is connected, and a second lifting device attached to the floating structure, to which lifting device the first end of the second cable is connected. With the aid of the lifting devices, the distance between the floating structure and the farming pipe can be changed, whereby the farming pipe can easily be arranged at a desired depth. The lifting devices also make it possible to change the position of the farming pipe. The position of the farming pipe is changed by lifting or lowering either end of the farming pipe with the lifting device. The lifting device to be used in the system can for example be a manual winch or an electric winch, where the cable winds around a roll.

According to one embodiment of the invention, the farming system comprises measuring means for measuring the temperature and/or flow rate and/or oxygen content of the water at different depths, and a control unit for controlling the first and the second lifting device based on one or more measurement results obtained from the measuring means. With the aid of the measuring means, information is obtained about water temperature and/or flow rate and/or oxygen content at different depths.

Based on this information, the depth is determined, where the farming conditions are optimal and at which depth it is useful to arrange the farming pipe with the aid of the lifting devices. The measuring means comprise one or more of the following sensors in order to measure the desired quantities: a temperature sensor, a flow sensor and an oxygen content sensor.

The measuring means can be attached to the farming pipe, by lifting and lowering which the measurings can be performed at different depths. The measuring means can be attached to a rope or the like, the first end of which is attached to the farming pipe or the floating structure and to the second end of which a weight can be attached. The measuring means can be arranged at one point on the rope, whereby the rope must be lifted or lowered in order to obtain measurement results from different depths. The measuring means can also be situated at several points of the rope, whereby the measurings can be performed at different depths, without having to lift or lower the rope.

The measuring means can comprise one or more sensors intended for measuring a certain quantity. If the measuring means comprise one sensor, the sensor is advantageously arranged to be moveable to different depths, either attached to the farming pipe or through other means. If water temperatures are for example measured with a temperature sensor at different depths, the depth most optimal for farming can be determined and the farming pipe can be lowered or lifted to this depth. If the measuring means comprise several sensors intended for measuring a certain quantity, the sensors are advantageously arranged at different depths. If the water temperature is for example measured with several temperature sensors at different depths, the depth most optimal for farming can be determined and the farming pipe can be lowered or lifted to this depth.

The control unit is configured to process the one or more measurement results obtained from the measuring means and to determine the depth, to which the farming pipe is moved based on the one or more measurement results obtained from the measuring means. The control unit is configured to control the lifting devices in order to lift or lower the farming pipe to an optimal depth. The control unit can comprise a memory for storing data, and a processor for processing data and controlling the lifting devices. The control unit can comprise a data transfer connection, which enables remote management of the control unit.

According to one embodiment of the invention, the connecting means comprise a first and a second shock absorber, the first ends of which are attached in connection with the floating structure and the second ends in connection with the farming pipe. In this embodiment, the farming pipe is attached to the floating structure with shock absorbers, with the help of which the farming pipe stays at a substantially constant distance from the floating structure. The farming pipe and the floating structure can move in relation to each other only as far as the shock absorbers stretch. The purpose of the shock absorbers is to dampen the movement conveyed from the floating structure to the farming pipe and from the farming pipe to the floating structure.

According to one embodiment of the invention, the farming system comprises an air tank attached to the farming pipe. A lifting force affects the air tank in the water, which lifting force reduces the load directed to the connecting means. The air tank can have a fixed volume, or its volume can be changeable, whereby the magnitude of the lifting force directed at the air tank can be changed by changing the volume of the air tank. The farming system can comprise a pump, with which air is pumped into the air tank, when it is desirable to increase the magnitude of the lifting force affecting it. One or more air tanks, which can be dimensioned on a case-to-case basis, can be attached to the farming pipe.

According to one embodiment of the invention, the farming system comprises a septic tank attached in connection to the end of the farming pipe, for collecting waste produced by aquatic animals farmed in the farming pipe. The septic tank is attached to the end of the farming pipe, from which the water passing through the farming pipe flows out, in other words to the outflow end of the farming pipe. Thus, the waste produced by the aquatic animals, passing with the water flowing through the farming pipe, can be efficiently collected. The septic tank is advantageously attached to the bottom of the farming pipe, so that the opening of the septic tank is directed toward the inflow end of the farming pipe.

According to one embodiment of the invention, the farming system comprises a guide plate attached inside the farming pipe for guiding the water flow. The guide plate is advantageously attached inside the farming pipe in a turning manner, whereby its position can be changed for example based on the flow rate of the water flowing through the farming pipe. The guide plate attached in a turning manner is arranged to be locked into different positions. The turning axis of the guide plate attached in a turning manner is advantageously arranged to be perpendicular in relation to the longitudinal axis of the farming pipe. The guide plate is advantageously circular and attached to the farming pipe at two points. With the aid of the guide plate attached inside the farming pipe, the water flow can be guided, so that the waste produced by the aquatic animals can be collected into the septic tank as efficiently as possible.

According to one embodiment of the invention, a filter has been attached to the end of the farming pipe for filtering the water flowing out of the farming pipe. Advantageously, all of the water flowing out of the farming pipe passes through the filter.

The filter efficiently prevents the fine-grained waste produced by the aquatic animals from getting into the water system.

According to one embodiment of the invention, the farming system comprises a feeding pipe for feeding the aquatic animals, the first end of which feeding pipe is arranged to extend inside the farming pipe. The feeding pipe is attached to the farming pipe. The feeding pipe can have a fixed length, whereby if the connecting means comprise lifting devices, the farming pipe meant for farming aquatic animals must be lifted to the upper position for feeding. The feeding pipe can alternatively be telescopic or for example rollable, whereby the feeding can be performed regardless of what depth the farming pipe has been lowered to. The second end of the feeding pipe is thus arranged in connection with the floating structure, and advantageously attached to it. The feeding pipe is advantageously elastic.

According to one embodiment of the invention, the farming system comprises anchoring means for attaching the floating structure in place, so that the floating structure can turn. The anchoring means can comprise for example a weight meant to be placed on the bottom of the water system, which weight is connected with an anchor rope to the floating structure. Because the anchoring means allow the floating structure to turn, the floating structure and the farming pipe attached thereto with the connecting means can settle in the flow direction of the water, whereby the water can efficiently flow through the farming pipe. The farming system can also comprise turning means, with which the farming pipe can be turned in a desired direction. The turning means can for example comprise a turning propulsion apparatus, which is attached to the floating structure.

In a typical farming method according to the invention, the farming system according to the invention is arranged in a water system, so that the floating structure floats on the water surface and the farming pipe is below the water surface and substantially horizontal, and aquatic animals are farmed in the farming pipe.

An advantage of the farming method according to the invention is that it reduces the stress of the aquatic animals being farmed and thus improves their well-being. Stress experienced by the fish is low, because the fish can swim against the water current. An advantage of the method according to the invention is also that it achieves a high growth rate of the aquatic animals, due to which the yearly production quantities are large. Additionally, an advantage of the farming method according to the invention is that its effects on the water system are minor, because the waste produced by the aquatic animals to a large part remains inside the farming pipe, from where it can easily be collected.

In a method according to one embodiment of the invention, the farming pipe is kept in the flow direction of the water.

In a method according to an embodiment of the invention, the temperature and/or flow rate and/or oxygen content of the water is measured at different depths, and the farming pipe is lifted or lowered based on one or more measurement results.

The embodiments and advantages mentioned in this text are in suitable parts applicable to both the farming system and farming method according to the invention, even if this is not always specifically mentioned.

### BRIEF DESCRIPTION OF THE DRAWING

In the following the invention will be described in more detail with reference to the embodiments presented as examples and the enclosed figures, in which

FIGS. 1a-1b show a farming system according to a first embodiment of the invention,

FIG. 2 shows a farming system according to a second embodiment of the invention, and

FIG. 3 shows a farming system according to a third embodiment of the invention.

### DETAILED DESCRIPTION OF THE DRAWING

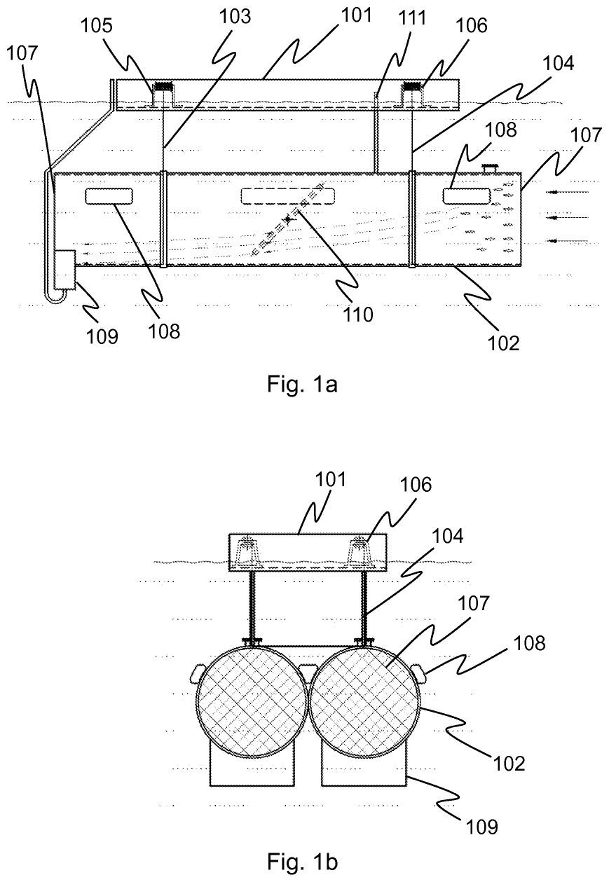

FIGS. 1a and 1b show the farming system according to the first embodiment of the invention as seen from the side and the end. The farming system is placed in the sea and it utilizes currents in the sea. The flow direction of the water is shown with arrows.

The farming system shown in FIGS. 1a and 1b comprises a floating structure 101 and two farming pipes 102 intended for farming fish, which are connected to the floating structure 101 with first and second cables 103, 104. A lifting force is directed to the floating structure 101 in the water, which lifting force keeps the floating structure 101 on the water surface. The farming pipes 102 meant for farming fish, which hang supported on the cables 103, 104, are below the water surface.

The first ends of the first cables 103 are connected to the first winches 105 attached to the floating structure 101, and the first ends of the second cables 104 are connected to the second winches 106 attached to the floating structure 101. With the aid of the winches 105, 106, the distance between the floating structure 101 and the farming pipes 102 can be changed, whereby the farming pipes 102 can be arranged at a desired depth. The winches 105, 106 also enable that the position of the farming pipes 102 can be changed by lifting or lowering either end of the farming pipes 102.

Nets 107 are attached to the ends of the farming pipes 102 intended for farming fish, which nets 107 enable the flow of water through the farming pipe 102 and prevent the fish in the farming pipe 102 from getting out of the farming pipe 102. The fish swim in the farming pipe 102 against the water current and flock in the end of the farming pipe 102, where water flows into the farming pipe 102. The nets 107 are attached in a detachable manner to the ends of the farming pipe 102, which makes it possible to place fish in the farming pipe 102 and to remove them from the farming pipe 102 without a separate hatch arranged in the farming pipe 102.

Air tanks 108 are attached to the outer surface of the farming pipes 102. A lifting force is directed to the air tanks 108 in the water, which lifting force reduces the load directed to the cables 103, 104 and winches 105, 106.

A septic tank 109 has been attached to the ends of both farming pipes 102, in which septic tank 109 the waste produced by the fish is collected. The septic tank 109 is attached to the end of the farming pipe 102, from which the water passing through the farming pipe 102 flows out, in other words to the outflow end of the farming pipe 102. The septic tank 109 is attached to the bottom of the farming pipe 102, so that its opening is directed toward the inflow end of the farming pipe 102. A guide plate 110 has been attached inside the farming pipe 102 for guiding the water flow. The guide plate 110 is attached in a turning manner and can be locked in different positions. With the aid of the guide plate 110 attached inside the farming pipe 102, the water flow is guided so that the waste produced by the fish is carried toward the septic tank 109.

The fish farming system has two feeding pipes 111 for feeding fish. The first end of the feeding pipe 111 is attached to the farming pipe 102 and the second end to the floating structure 101. The feeding pipe 111 is a flexible plastic pipe, the length of which is selected so that the fish can be fed also when the farming pipe 102 is lowered to its lower position.

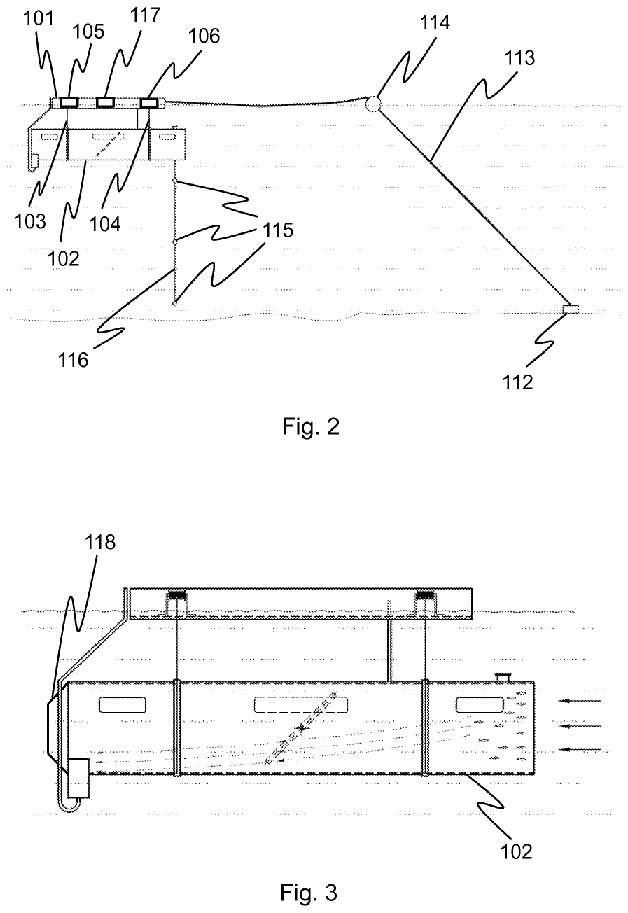

FIG. 2 shows the farming system according to the second embodiment of the invention. The farming system is attached in place with anchoring means, which comprise a weight 112 set on the bottom of the sea and an anchor rope 113, the first end of which is attached to the floating structure 101 and the second end to the weight 112. A buoy 114 is additionally attached to the anchor rope 113, which buoy divides the anchor rope 113 into two parts. The anchoring means allow the floating structure 101 to turn, so that the floating structure 101 and the farming pipes 102 attached thereto with cables 103, 104 can settle in the flow direction of the water.

The farming system shown in FIG. 2 has measuring means 115 for measuring the temperature, flow rate and oxygen content of the water at three different depths. The measuring means 115 are attached to a rope 116 at three different points, the first end of which rope 116 is attached to one of the farming pipes 102. The farming system has a control unit 117 for controlling the winches 105, 106 based on one or more measurement results obtained from the measuring means 115. The control unit 117 determines, based on the measurement results obtained from the measuring means 115, the depth where the conditions are optimal for farming fish. When the depth is determined, the farming pipes 102 are moved to this depth.

FIG. 3 shows the farming system according to the third embodiment of the invention. The farming system differs from the farming system shown in FIGS. 1a and 1b in that a filter 118 has been attached to the outflow end of the farming pipe 102 in order to filter the water flowing out of the farming pipe 102.

It is obvious to a person skilled in the art that the invention is not limited merely to the above-described examples, but the invention may vary within the scope of the claims presented below. The dependent claims present some possible embodiments of the invention, and they are as such not to be considered to restrict the protective scope of the invention.

1. A farming system, which comprises:
a floating structure,
wherein the farming system comprises:
a farming pipe, to the ends of which end pieces are attached, which have openings in order to enable the flow of water through the farming pipe, and
connecting means, with which the farming pipe is connected to the floating structure, so that the farming pipe is substantially horizontal in the water.

2. The farming system according to claim 1, wherein the connecting means comprise a first and a second cable, the first ends of which are attached in connection with the floating structure and the second ends in connection with the farming pipe.

3. The farming system according to claim 2, wherein the connecting means comprise a first lifting device attached to the floating structure, to which lifting device the first end of the first cable is connected, and a second lifting device attached to the floating structure, to which lifting device the first end of the second cable is connected.

4. The farming system according to claim 3, wherein the farming system comprises measuring means for measuring the temperature and/or flow rate and/or oxygen content of the water at different depths, and a control unit for controlling the first and the second lifting device based on one or more measurement results obtained from the measuring means.

5. The farming system according to claim 1, wherein the connecting means comprise a first and a second shock absorber, the first ends of which are attached in connection with the floating structure and the second ends in connection with the farming pipe.

6. The farming system according to claim 1, wherein the farming system comprises an air tank attached to the farming pipe.

7. The farming system according to claim 1, wherein the farming system comprises a septic tank attached in connection to the end of the farming pipe, for collecting waste produced by aquatic animals farmed in the farming pipe.

8. The farming system according to claim 1, wherein the farming system comprises a guide plate attached inside the farming pipe for guiding the water flow.

9. The farming system according to claim 2, wherein a filter has been attached to the end of the farming pipe in order to filter the water flowing out of the farming pipe.

10. The farming system according to claim 1, wherein the farming system comprises a feeding pipe for feeding the aquatic animals, the first end of which feeding pipe is arranged to extend inside the farming pipe.

11. The farming system according to claim 1, wherein the farming system comprises anchoring means for attaching the floating structure in place, so that the floating structure can turn.

12. A farming method comprising:
arranging a farming system according to the farming system of claim 1 in a water system, so that the floating structure floats on the water surface and the farming pipe is below the water surface and substantially horizontal, and
farming aquatic animals in a farming pipe.

13. The farming method according to claim 12, wherein the farming pipe is kept in the flow direction of the water.

14. The farming method according to claim 12, wherein the temperature and/or flow rate and/or oxygen content of the water is measured at different depths, and the farming pipe is lifted or lowered based on one or more measuring results.
